(19) United States
(12) Patent Application Publication
(10) Pub. No.: US 2022/0101722 A1
(43) Pub. Date: Mar. 31, 2022

(54) ROAD ENTRY SYSTEM AND METHOD FOR VEHICLE

(71) Applicant: HYUNDAI MOBIS CO., LTD., Seoul (KR)

(72) Inventor: Hyung Myung LEE, Suwon-si (KR)

(73) Assignee: HYUNDAI MOBIS CO., LTD., Seoul (KR)

(21) Appl. No.: 17/474,379

(22) Filed: Sep. 14, 2021

(30) Foreign Application Priority Data
Sep. 29, 2020 (KR) 10-2020-0127081

(51) Int. Cl. G08G 1/01; B62D 15/02; H04W 4/44; B60W 30/10

(52) U.S. Cl. CPC G08G 1/0141; G08G 1/0133; B62D 15/021; B60W 2554/4049; B60W 30/10; B60W 2552/53; H04W 4/44

(57) ABSTRACT

A road entry system of a vehicle includes: a sensing unit configured to sense position information or movement information of an external obstacle located on a side or a rear of the vehicle, in response to the vehicle entering an entrance lane; a determining unit configured to determine whether the entrance lane is congested, based on the position information or the movement information of the external obstacle, as sensed by the sensing unit; and a control unit configured to control driving of the vehicle based on a result of the determining of whether the entrance lane is congested.

### CROSS REFERENCE TO RELATED APPLICATIONS

This application claims to the benefit under 35 U.S.C. § 119(a) of Korean Patent Application No. 10-2020-0127081 filed on Sep. 29, 2020 in the Korean Intellectual Property Office, the entire disclosure of which is incorporated herein by reference for all purposes.

### BACKGROUND

### Field of the Invention

The present invention relates to a road entry system and method for a vehicle, and more particularly, to a technique for controlling driving of a vehicle according to a traffic condition of an entrance lane.

### Description of the Related Art

Generally, a vehicle is provided with a rear detecting sensor that senses an external obstacle located on a side or a rear of the vehicle.

A conventional rear detecting sensor may generate an alert signal to a driver for an external obstacle located on a side or a rear of a vehicle when the vehicle changes lanes.

With the recent development of autonomous driving vehicles, when the driver shows an intent to change lanes, the vehicle merely determines based on the conventional rear detecting sensor whether lane change is possible within a specific time from this point, and performs the lane change.

However, when the vehicle enters an entrance lane in an entrance zone from a narrow road to a wide road like a zone where the vehicle enters a highway, it is difficult for the vehicle to detect an external vehicle on the entrance lane through the rear detecting sensor, resulting in collision between the external vehicle on the entrance lane and the vehicle.

The matters described as the background art are merely for improving the understanding of the background of the present invention, and should not be accepted as acknowledging that they correspond to the prior art known to those of ordinary skill in the art.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a road entry system of a vehicle includes: a sensing unit configured to sense position information or movement information of an external obstacle located on a side or a rear of the vehicle, in response to the vehicle entering an entrance lane; a determining unit configured to determine whether the entrance lane is congested, based on the position information or the movement information of the external obstacle, as sensed by the sensing unit; and a control unit configured to control driving of the vehicle based on a result of the determining of whether the entrance lane is congested.

The sensing unit may be further configured to sense the position information or the movement information of the external obstacle by being connected to a camera sensor or a radar sensor mounted on the vehicle.

The sensing unit may be further configured to sense the position information or the movement information of the external obstacle by being connected to an infrastructure or an external vehicle that provides traffic information of the entrance lane via wireless communication.

The sensing unit may be further configured to sense the position information or the movement information of the external obstacle through a camera sensor or a radar sensor, or sense the position information or the movement information of the external obstacle by being connected to an infrastructure or an external vehicle that provides traffic information of the entrance lane via wireless communication. The determining unit may be further configured to set a vehicle collision index based on the position information or the movement information of the external obstacle, as sensed by the sensing unit from the camera sensor, the radar sensor, the infrastructure, or the external vehicle.

The determining unit, when setting the vehicle collision index based on a connection state of wireless communication with the infrastructure or the external vehicle, a sensing state of the camera sensor or the radar sensor, or a position state of the external obstacle, may set a weight value for information of the external obstacle, as sensed by the sensor camera sensor or the radar sensor, or information of the external obstacle, as transmitted via wireless communication.

The determining unit may be further configured to determine that the entrance lane is congested, in response to the vehicle collision index being greater than or equal to a preset value. The control unit may be further configured to limit a moving speed of the vehicle or perform control to increase a steering angle of the vehicle when the vehicle enters the entrance lane, in response to the determining unit determining that the entrance lane is congested.

The sensing unit may be further configured to sense the position information or the movement information of the external obstacle, in response to the determining unit determining that the entrance lane is congested after the vehicle enters the entrance lane. The determining unit may be further configured to determine a traffic condition of a side lane based on the position information or the movement information of the external obstacle, as sensed by the sensing unit.

The control unit may be further configured to control driving of the vehicle such that the vehicle enters the side lane while increasing a moving speed of the vehicle based on the position information or the movement information of the external obstacle, as sensed by the sensing unit, in response to determining that the traffic condition of the side lane is smooth.

The road entry system may further include a navigation configured to set a driving path of the vehicle. The navigation may be further configured to set a detour path where a traffic condition of the side lane is smooth, in response to the determining unit determining that the traffic condition of the side lane is congested. The control unit may be further configured to control driving of the vehicle based on the detour path.

In another general aspect, a road entry method of a vehicle includes: sensing position information or movement information of an external obstacle located on a side or a rear of the vehicle, in response to the vehicle entering an entrance lane; determining whether the entrance lane is congested, based on the position information or the movement information of the external obstacle, as sensed in the sensing operation; and controlling driving of the vehicle based on a result of the determining of whether the entrance lane is congested.

The sensing of the position information or the movement information may include sensing the position information or the movement information by using a camera sensor or a radar sensor mounted on the vehicle.

The sensing of the position information or the movement information may include sensing the position information or the movement information by using an infrastructure or an external vehicle that provides traffic information of the entrance lane via wireless communication.

The sensing of the position information or the movement information may include sensing the position information or the movement information by using a camera sensor or a radar sensor, or sensing the position information or the movement information by using an infrastructure or an external vehicle that provides traffic information of the entrance lane via wireless communication. The determining of whether the entrance lane is congested may include setting a vehicle collision index based on the position information or the movement information of the external obstacle, as sensed from the camera sensor, the radar sensor, the infrastructure, or the external vehicle.

The determining of whether the entrance lane is congested may include, when setting the vehicle collision index based on a connection state of wireless communication with the infrastructure or the external vehicle, a sensing state of the camera sensor or the radar sensor, or a position state of the external obstacle, setting a weight value for information of the external obstacle, as sensed by the camera sensor or the radar sensor, or information of the external obstacle, as transmitted via wireless communication.

The determining of whether the entrance lane is congested may include determining that the entrance lane is congested, in response to the vehicle collision index being greater than or equal to a preset value. The controlling of the driving of the vehicle may include limiting a moving speed of the vehicle or performing control to increase a steering angle of the vehicle when the vehicle enters the entrance lane, in response to determining that the entrance lane is congested.

The road entry method may further include sensing the position information or the movement information of the external obstacle, in response to determining that the entrance lane is congested after the vehicle enters the entrance lane, and determining a traffic condition of a side lane based on the position information or the movement information of the external obstacle on the side lane.

The road entry method may further include controlling driving of the vehicle such that the vehicle enters the side lane while increasing the speed of the vehicle based on the position information or the movement information of the external obstacle, as sensed in the determining of the traffic condition of the side lane, in response to determining that the traffic condition of the side lane is smooth.

The road entry method may further include: setting a detour route by using a navigation that sets a driving path of the vehicle, in response to determining that the traffic condition of the side lane is congested; and controlling driving of the vehicle based on the detour path.

In another general aspect, a non-transitory computer-readable storage medium stores instructions that, when executed by a processor, cause the processor to perform the method described above.

Other features and aspects will be apparent from the following detailed description, the drawings, and the claims.

### BRIEF DESCRIPTION OF THE DRAWINGS

FIG. 1 is a block diagram of a road entry system of a vehicle, according to an embodiment of the present invention;

FIG. 2 shows sensing of an external vehicle when a vehicle enters an entrance lane in a road entry system of the vehicle according to an embodiment of the present invention;

FIGS. 3 and 4 show sensing of an external vehicle on a side lane after a vehicle enters an entrance lane, in a road entry system of the vehicle according to an embodiment of the present invention;

and

FIG. 5 is a flowchart of a road entry method of a vehicle, according to an embodiment of the present invention.

### DETAILED DESCRIPTION

For embodiments of the present invention disclosed in the present specification or application, specific structural or functional descriptions are only exemplified for the purpose of describing the embodiments of the present invention, and the embodiments of the present invention may be implemented in various forms, and should not be construed as being limited to the embodiments described in the present specification or application.

Since an embodiment according to the present invention may have various changes and may have various forms, specific embodiments will be illustrated in the drawings and described in detail in the present specification or application. However, such a description is not construed as limiting an embodiment according to the concept of the present invention to a specified disclosure, and should be understood as including all changes, equivalents, or substitutes included in the spirit and technical scope of the present invention.

Terms such as first and/or second, etc., may be used to describe various components, but the components should not be limited to those terms. The terms are used only for the purpose of distinguishing one component from another component, for example, without departing from the scope of the present invention, a first component may be referred to as a second component, and similarly, the second component may also be referred to as the first component.

When a component is referred to as being “connected” or “accessed” to or by any other component, it should be understood that the component may be directly connected or accessed by the other component, but another new component may also be interposed between them. Contrarily, when a component is referred to as being “directly connected” or “directly joined” to or by any other component, it should be understood that there is no component between the component and the other component. Other expressions describing a relationship between components, that is, “between” and “immediately between”, “adjacent to” and “directly adjacent to”, etc., should be interpreted similarly.

The terms used in the present specification are used for the purpose of describing particular exemplary embodiments only and are not intended to be limiting. As used herein, the singular forms are intended to include the plural forms as well, unless the context clearly indicates otherwise. In the present specification, it will be further understood that the terms “comprises” and/or “has,” specify the presence of feature, number, step, operation, component, element, or combination thereof, but do not preclude the presence or addition of one or more other features, numbers, steps, operations, components, elements, or combinations thereof.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having ideal or exaggerated meanings unless they are clearly defined in the present specification.

Hereinafter, preferred embodiments of the present invention will be described in detail with reference to the accompanying drawings. Like reference numerals indicated in the drawings refer to like members.

A sensing unit 10, a determining unit 20, and a control unit 30 according to an exemplary embodiment of the present invention may be implemented through non-volatile memory (not shown) configured to store data regarding an algorithm for controlling operations of various components of a vehicle or software instructions for reproducing the algorithm and a processor (not shown) configured to perform operations described below by using the data stored in the memory. Herein, the memory and the processor may be implemented as separate chips. Alternatively, the memory and the processor may be implemented as an integrated single chip. The processor may have a form of one or more processors.

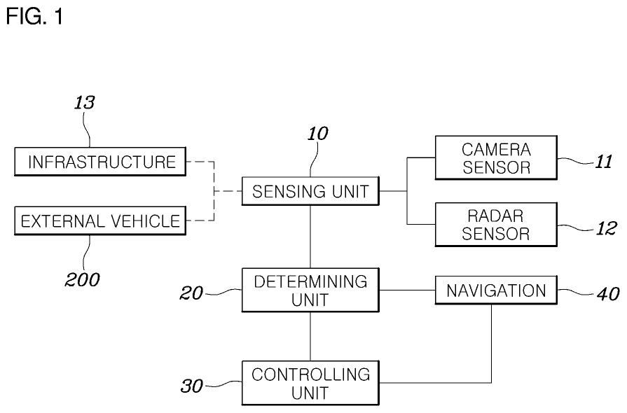

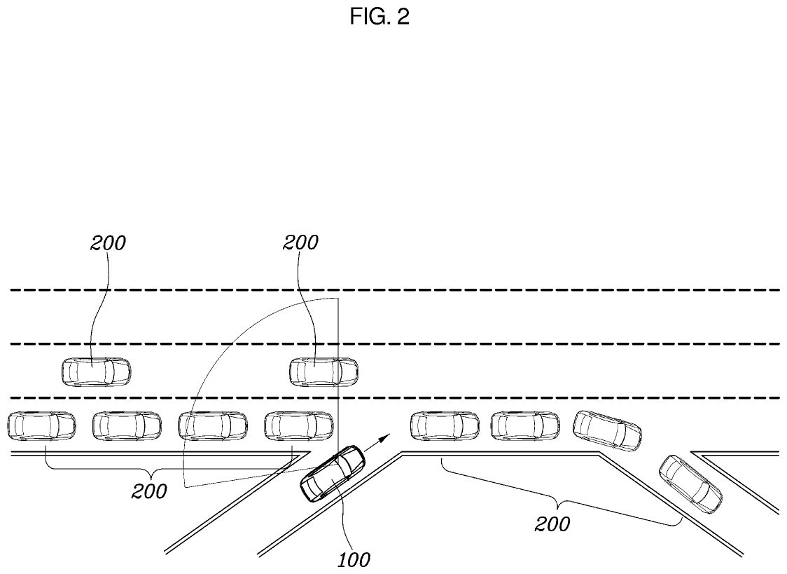

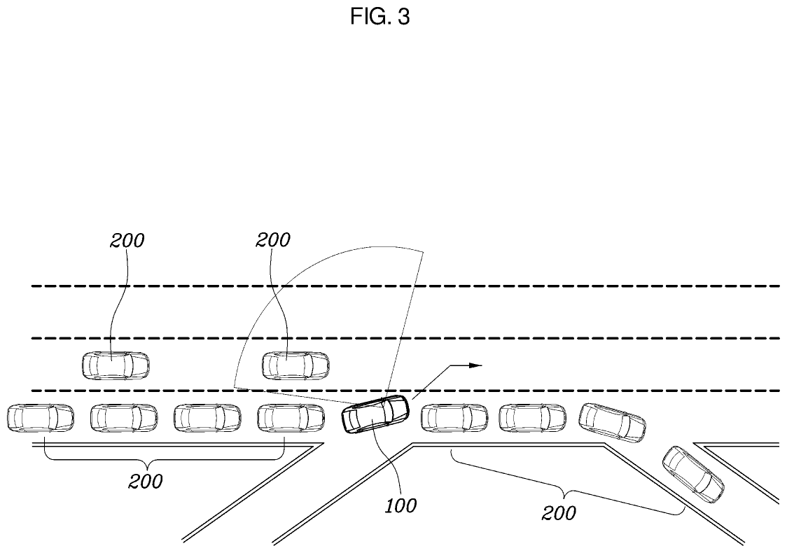

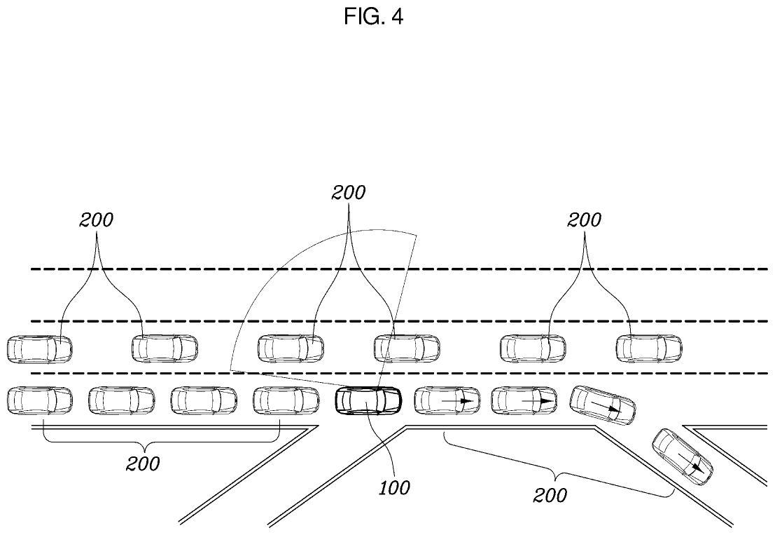

FIG. 1 is a structural diagram of a road entry system of a vehicle 100 according to an embodiment of the present invention, FIG. 2 shows sensing of an external obstacle 200 when the vehicle 100 enters an entrance lane, in a road entry system of the vehicle 100 according to an embodiment of the present invention, and FIGS. 3 and 4 sensing of the external obstacle 200 on a side lane after the vehicle 100 enters the entrance lane, in the road entry system of the vehicle 100.

With reference to FIGS. 1 through 4 attached, a preferred embodiment of the road entry system of the vehicle 100 according to the present invention will be described below.

The road entry system of the vehicle 100 according to the present invention has been developed to allow the vehicle 100 to safely enter an entrance lane by sensing an external obstacle 200 such as an external vehicle or a motorcycle located on an entrance lane in a section where the vehicle 100 enters a main road such as a highway and to change lanes when the entrance lane is congested.

The road entry system of the vehicle 100 according to the present invention may be applied to an autonomous driving vehicle 100 and may also be applied to a general vehicle 100 to assist driving of a driver.

The road entry system of the vehicle 100 according to the present invention may include a sensing unit 10 that senses position information or movement information of the external obstacle 200 located on a side or read of the vehicle 100, a determining unit 20 that determines based on the position information or the movement information of the external obstacle 200, sensed by the sensing unit 10, whether the entrance lane is congested, and a control unit 30 that controls driving of the vehicle 100 based whether the entrance lane is congested, determined by the determining unit 20.

As shown in FIG. 1, the sensing unit 10 may sense the external obstacle 200 located on the side or the rear when the vehicle 100 enters the entrance lane, and sense position information regarding a distance between the external obstacle 200 and the vehicle 100 or movement information regarding a relative speed between the external obstacle 200 and the vehicle 100.

The determining unit 20 may determine whether the entrance lane is congested, from the position information of the external obstacle 200, sensed by the sensing unit 10, or from the number and a speed of the external obstacle 200 located on the entrance lane, identified based on the position information.

As shown in FIG. 2, according to an embodiment, when the vehicle 100 enters the entrance lane, the sensing unit 10 may sense the external obstacle 200 and determine whether the entrance lane is congested.

The control unit 30 may control driving of the vehicle 100, such as a speed or a steering angle of the vehicle 100, based on whether the entrance lane is congested, determined by the determining unit 20, when the vehicle 100 enters the entrance lane.

In an embodiment, when the determining unit 20 determines that the entrance lane is congested, the control unit 30 may reduce the speed of the vehicle 100 or increase the steering angle for entrance between a plurality of external obstacles 200 congested.

In another embodiment, when the determining unit 20 determines that the entrance lane is not congested, the control unit 30 may cause the vehicle 100 to enter the entrance lane by controlling the speed of the vehicle 100 based on the movement information of the external obstacle 200 on the entrance lane.

In this way, the vehicle 100 may safely enter the entrance lane when entering the entrance lane.

The sensing unit 10 may be connected to the camera sensor 11 or the radar sensor 12 mounted on the vehicle 100 to sense the position information or the movement information of the external obstacle 200 located on the side or the rear of the vehicle 100.

The sensing unit 10 may sense the external obstacle 200 by being connected to the camera sensor 11 or the radar sensor 12 mounted on the vehicle 100 to sense the external obstacle 200 located on the side or the rear of the vehicle 100, and a sensor connected to the sensing unit 10 may further include an ultrasonic sensor or a lidar sensor as well the camera sensor 11 and the radar sensor 12 described above.

The camera sensor 11 may capture the external obstacle 200 and sense position information from an image obtained by capturing the external obstacle 200, and the radar sensor 12 may sense the position information or the movement information of the external obstacle 200 with electromagnetic waves.

The sensing unit 10 may be connected to an infrastructure 13 or the external obstacle 200, which provides traffic information of the entrance lane of the vehicle 100, via wireless communication to sense the position information or the movement information of the external obstacle 200 located on the side or the rear of the vehicle 100.

The sensing unit 10 may be provided with the traffic information of the entrance lane by being connected to the infrastructure 13 or a plurality of external obstacles 200 providing road traffic information of a road where the entrance lane is located to sense the external obstacle 200 via wireless communication, and may sense the external obstacle 200 located on the entrance lane from the traffic information.

The sensing unit 10 may accurately sense the position information or the movement information of the external obstacle 200, based on sensing information obtained through the sensor mounted on the vehicle 100 and the traffic information received from the infrastructure 13 or the external obstacle 200 connected via wireless communication.

The sensing unit 10 may sense the position information or the movement information of the external obstacle 200 through the camera sensor 11 or the radar sensor 12 or sense the position information or the movement information of the external obstacle 200 by being connected to the infrastructure 13 or the external obstacle 200 via wireless communication, and the determining unit 20 may set a vehicle collision index based on the position information or the movement information of the external obstacle 200 sensed by the sensing unit 10 from the camera sensor 11, the radar sensor 12, the infrastructure 13, or the external obstacle 200.

The determining unit 20 may set the vehicle collision index calculated by numerically calculating the possibility of collision between the vehicle 100 and the external obstacle 200 based on the position information or the movement information of the external obstacle 200, sensed by the sensing unit 10.

The vehicle collision index may be set high when the entrance lane is congested due to a large number of external obstacles 200 on the entrance lane, and may be set low when the entrance is not congested.

When the determining unit 20 sets the vehicle collision index based on a connection state of wireless communication with the infrastructure 13 or the external obstacle 200, a sensing state of the sensor, or a position state of the external obstacle 200, the determining unit 20 may set a weight value for information of the external obstacle 200, sensed by the sensor, or information of the external obstacle 200, transmitted via wireless communication.

The determining unit 20 may set the vehicle collision index based on the sensing information of the sensor or the traffic information received from the infrastructure 13 or the external obstacle 200 connected via wireless communication.

In this case, the determining unit 20 may set a weight value for the sensing information of the sensor or the traffic information received from the infrastructure 13 or the external obstacle 200, based on the connection state of wireless communication or the sensing state of the sensor.

It may become difficult to receive the traffic information from the infrastructure 13 or the external obstacle 200 when the connection state of wireless communication is not good, the sensor may not be able to accurately sense the external obstacle 200 due to an external weather condition or a foreign substance on the sensor, and the traffic condition of the entrance lane may be difficult to accurately sense when a position of the external obstacle 200 is out of a sensing range of the sensor.

Thus, the determining unit 20 may set the vehicle collision index by giving a weight value to the traffic information received from the infrastructure 13 or the external obstacle 200 connected via wireless communication in a situation where the external obstacle 200 is difficult to sense through the sensor, and may set the vehicle collision index by giving a weight value to the sensing information of the sensor in a situation where the traffic information is difficult to receive from the infrastructure 13 or the external obstacle 200 connected via wireless communication.

The determining unit 20 may determine that the entrance lane is congested when the vehicle collision index is greater than or equal to a preset value, and when the determining unit 20 determines that the entrance lane is congested, the control unit 30 may limit a moving speed of the vehicle 100 or control to increase a steering angle of the vehicle 100 when the vehicle 100 enters the entrance lane.

The determining unit 20 may set the vehicle collision index for the entrance lane, and determine that the entrance lane is congested when the vehicle collision index is greater than or equal to a preset value.

The control unit 30 may control driving of the vehicle 100 such that the control unit 30 may limit the speed of the vehicle 100 to a preset speed or less to allow the vehicle 100 to safely enter the entrance lane when the vehicle 100 enters the entrance lane, or may increase the steering angle of the vehicle 100 to allow the vehicle 100 to enter the entrance lane among the plurality of external obstacles 200 when the vehicle 100 enters the entrance lane.

When the determining unit 20 determines that the entrance lane is congested after the vehicle 100 enters the entrance lane, the sensing unit 10 may sense the position information or the movement information of the external obstacle 200 on the side or the rear, and the determining unit 20 may determine a traffic condition of a side lane based on the position information or the movement information of the external obstacle 200 on the side or the rear, sensed by the sensing unit 10.

After the determining unit 20 determines that the entrance lane is congested and the vehicle 100 enters the entrance lane, the vehicle 100 needs to move to the side lane to leave a congested section.

To this end, the sensing unit 10 may sense the position information or the movement information of the external obstacle 200 located on the side lane, and the determining unit 20 may determine a traffic condition of the side lane based on the position information or the movement information of the external obstacle 200, sensed by the sensing unit 10.

In this way, the vehicle 100 may recognize the traffic condition of the side lane to leave the congested section.

When the determining unit 20 determines that the traffic condition of the side lane is smooth, the control unit 30 may control driving of the vehicle 100 to allow the vehicle 100 to enter the side lane while increasing the speed of the vehicle 100 based on the position information or the movement information of the external obstacle 200 located on the side or the rear of the vehicle 100, sensed by the sensing unit 10.

When the determining unit 20 determines that the traffic condition of the side lane is smooth, the control unit 30 may move the vehicle 100 to the side lane when the external obstacle 200 is not located on the side or the rear of the vehicle 100, based on position information of the external obstacle 200 located on the side lane, or the control unit 30 may move the vehicle 100 to the side lane while increasing the speed of the vehicle 100 to a speed that is similar to the speed of the external obstacle 200, based on the movement information of the external obstacle 200 located on the side lane.

The road entry system may further include a navigation 40 that sets a driving path, and when the determining unit 20 determines that the traffic condition of the side lane is congested, the navigation 40 may set a detour path where a traffic condition is smooth, and the control unit 30 may control driving of the vehicle 100 based on the detour path set by the navigation 40.

As shown in FIG. 4, when the determining unit 20 determines that both the entrance lane and the side lane are congested, the navigation 40 may search for a detour path where a traffic condition is smooth, instead of the current path, and the control unit 30 may control driving of the vehicle 100 according to the detour path found in the navigation 40.

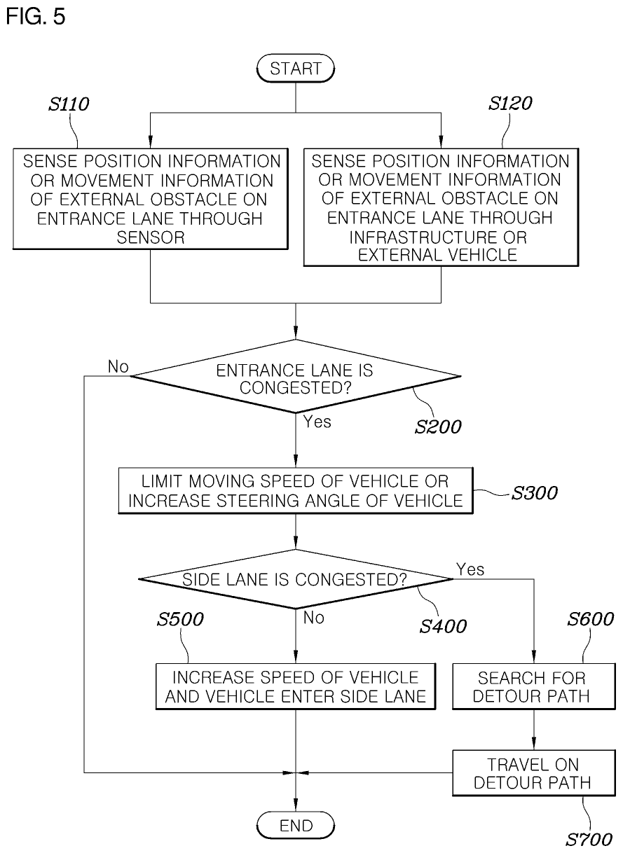

FIG. 5 is a flowchart of a road entry method of the vehicle 100, according to an embodiment of the present invention.

With reference to FIG. 5, a preferred embodiment of the road entry method of the vehicle 100 according to the present invention will be described below.

The road entry method of the vehicle 100 according to the present invention may include sensing operation S100 of sensing position information or movement information of the external obstacle 200 located on a side or read of the vehicle 100, determining operation S200 of determining based on the position information or the movement information of the external obstacle 200, sensed in sensing operation S100, whether an entrance lane is congested, and control operation S300 of controlling driving of the vehicle 100 based on whether the entrance lane is congested, determined in determining operation S200.

Sensing operation S100 may include operation S110 of sensing the position information or the movement information of the external obstacle 200 located on the side or the rear of the vehicle 100 by being connected to a camera sensor or a radar sensor mounted on the vehicle 100.

Sensing operation S100 may further include operation S120 of sensing the position information or the movement information of the external obstacle 200 located on the side or the rear of the vehicle 100 by being connected to an infrastructure or an external vehicle providing traffic information of the entrance lane of the vehicle 100 via wireless communication.

Sensing operation S100 may include sensing the position information or the movement information of the external obstacle 200 through the camera sensor or the radar sensor or sensing the position information or the movement information of the external obstacle 200 by being connected to the infrastructure or the external vehicle via wireless communication, and determining operation S200 may include setting a vehicle collision index based on the position information or the movement information of the external obstacle 200 sensed in sensing operation S100 from the camera sensor, the radar sensor, the infrastructure, or the external vehicle.

Determining operation S200 may include, when setting the vehicle collision index based on a connection state of wireless communication with the infrastructure or the external vehicle, a sensing state of the sensor, or a position state of the external obstacle 200, setting a weight value for information of the external obstacle 200, sensed by the sensor, or information of the external obstacle 200, transmitted via wireless communication.

Determining operation S200 may include determining that the entrance lane is congested when the vehicle collision index is greater than or equal to a preset value, and control operation S300 may include, when determining that the entrance lane is congested, limiting a moving speed of the vehicle 100 or controlling to increase the steering angle when the vehicle 100 enters the entrance lane.

The road entry method of the vehicle 100 according to the present invention may further include operation S400 of sensing the position information or the movement information of the external obstacle 200 when determining that the entrance lane is congested after the vehicle 100 enters the entrance lane and determining a traffic condition of a side lane based on the position information or the movement information of the external obstacle 200 on the side lane.

The road entry method of the vehicle 100 according to the present invention may further include operation S500 of, when determining that the traffic condition of the side lane is smooth in the operation of determining the traffic condition of the side lane, controlling driving of the vehicle 100 to cause the vehicle 100 to enter the side lane while increasing the speed of the vehicle 100 based on the position information or the movement information of the external obstacle 200 located on the side or the rear of the vehicle 100, sensed in the operation of determining the traffic condition of the side lane.

The navigation 40 for setting a driving path of the vehicle 100 is further provided, and the road entry method may further include operation S600 where the navigation 40 sets a detour path when determining that the traffic condition of the side lane is congested in the operation of determining the traffic condition of the side lane, and operation S700 of controlling driving of the vehicle 100 based on the detour path set by the navigation 40.

While the present invention has been shown and described in relation to specific embodiments thereof, it would be obvious to those of ordinary skill in the art that the present invention can be variously improved and changed without departing from the spirit of the present invention provided by the following claims.

What is claimed is:

1. A road entry system of a vehicle, comprising:
a sensing unit configured to sense position information or movement information of an external obstacle located on a side or a rear of the vehicle, in response to the vehicle entering an entrance lane;
a determining unit configured to determine whether the entrance lane is congested, based on the position information or the movement information of the external obstacle, as sensed by the sensing unit; and
a control unit configured to control driving of the vehicle based on a result of the determining of whether the entrance lane is congested.

2. The road entry system of claim 1, wherein the sensing unit is further configured to sense the position information or the movement information of the external obstacle by being connected to a camera sensor or a radar sensor mounted on the vehicle.

3. The road entry system of claim 1, wherein the sensing unit is further configured to sense the position information or the movement information of the external obstacle by being connected to an infrastructure or an external vehicle that provides traffic information of the entrance lane via wireless communication.

4. The road entry system of claim 1, wherein the sensing unit is further configured to sense the position information or the movement information of the external obstacle through a camera sensor or a radar sensor, or sense the position information or the movement information of the external obstacle by being connected to an infrastructure or an external vehicle that provides traffic information of the entrance lane via wireless communication, and
wherein the determining unit is further configured to set a vehicle collision index based on the position information or the movement information of the external obstacle, as sensed by the sensing unit from the camera sensor, the radar sensor, the infrastructure, or the external vehicle.

5. The road entry system of claim 4, wherein the determining unit, when setting the vehicle collision index based on a connection state of wireless communication with the infrastructure or the external vehicle, a sensing state of the camera sensor or the radar sensor, or a position state of the external obstacle, sets a weight value for information of the external obstacle, as sensed by the sensor camera sensor or the radar sensor, or information of the external obstacle, as transmitted via wireless communication.

6. The road entry system of claim 4, wherein the determining unit is further configured to determine that the entrance lane is congested, in response to the vehicle collision index being greater than or equal to a preset value, and
wherein the control unit is further configured to limit a moving speed of the vehicle or perform control to increase a steering angle of the vehicle when the vehicle enters the entrance lane, in response to the determining unit determining that the entrance lane is congested.

7. The road entry system of claim 1, wherein the sensing unit is further configured to sense the position information or the movement information of the external obstacle, in response to the determining unit determining that the entrance lane is congested after the vehicle enters the entrance lane, and
wherein the determining unit is further configured to determine a traffic condition of a side lane based on the position information or the movement information of the external obstacle, as sensed by the sensing unit.

8. The road entry system of claim 7, wherein the control unit is further configured to control driving of the vehicle such that the vehicle enters the side lane while increasing a moving speed of the vehicle based on the position information or the movement information of the external obstacle, as sensed by the sensing unit, in response to determining that the traffic condition of the side lane is smooth.

9. The road entry system of claim 7, further comprising a navigation configured to set a driving path of the vehicle,
wherein the navigation is further configured to set a detour path where a traffic condition of the side lane is smooth, in response to the determining unit determining that the traffic condition of the side lane is congested, and
wherein the control unit is further configured to control driving of the vehicle based on the detour path.

10. A road entry method of a vehicle, comprising:
sensing position information or movement information of an external obstacle located on a side or a rear of the vehicle, in response to the vehicle entering an entrance lane;
determining whether the entrance lane is congested, based on the position information or the movement information of the external obstacle, as sensed in the sensing operation; and
controlling driving of the vehicle based on a result of the determining of whether the entrance lane is congested.

11. The road entry method of claim 10, wherein the sensing of the position information or the movement information comprises sensing the position information or the movement information by using a camera sensor or a radar sensor mounted on the vehicle.

12. The road entry method of claim 10, wherein the sensing of the position information or the movement information comprises sensing the position information or the movement information by using an infrastructure or an external vehicle that provides traffic information of the entrance lane via wireless communication.

13. The road entry method of claim 10, wherein the sensing of the position information or the movement information comprises sensing the position information or the movement information by using a camera sensor or a radar sensor, or sensing the position information or the movement information by using an infrastructure or an external vehicle that provides traffic information of the entrance lane via wireless communication, and
wherein the determining of whether the entrance lane is congested comprises setting a vehicle collision index based on the position information or the movement information of the external obstacle, as sensed from the camera sensor, the radar sensor, the infrastructure, or the external vehicle.

14. The road entry method of claim 13, wherein the determining of whether the entrance lane is congested comprises, when setting the vehicle collision index based on a connection state of wireless communication with the infrastructure or the external vehicle, a sensing state of the camera sensor or the radar sensor, or a position state of the external obstacle, setting a weight value for information of the external obstacle, as sensed by the camera sensor or the radar sensor, or information of the external obstacle, as transmitted via wireless communication.

15. The road entry method of claim 13, wherein the determining of whether the entrance lane is congested comprises determining that the entrance lane is congested, in response to the vehicle collision index being greater than or equal to a preset value, and
wherein the controlling of the driving of the vehicle comprises limiting a moving speed of the vehicle or performing control to increase a steering angle of the vehicle when the vehicle enters the entrance lane, in response to determining that the entrance lane is congested.

16. The road entry method of claim 10, further comprising sensing the position information or the movement information of the external obstacle, in response to determining that the entrance lane is congested after the vehicle enters the entrance lane, and determining a traffic condition of a side lane based on the position information or the movement information of the external obstacle on the side lane.

17. The road entry method of claim 16, further comprising controlling driving of the vehicle such that the vehicle enters the side lane while increasing the speed of the vehicle based on the position information or the movement information of the external obstacle, as sensed in the determining of the traffic condition of the side lane, in response to determining that the traffic condition of the side lane is smooth.

18. The road entry method of claim 16, further comprising:
setting a detour route by using a navigation that sets a driving path of the vehicle, in response to determining that the traffic condition of the side lane is congested; and
controlling driving of the vehicle based on the detour path.

19. A non-transitory computer-readable storage medium storing instructions that, when executed by a processor, cause the processor to perform the method of claim 10.
